(19) United States
(12) Patent Application Publication
(10) Pub. No.: US 2024/0235373 A9
(43) Pub. Date: Jul. 11, 2024

(54) COMMON MODE FILTER WITH Y-CAPACITORS AND SEPARATING SWITCH FOR DECOUPLING SAME FROM THE REFERENCE POTENTIAL

(71) Applicant: Valeo eAutomotive Germany GmbH, Erlangen (DE)

(72) Inventors: Guido RASEK, Erlangen (DE); Alexander BUCHER, Erlangen (DE); Georgios LEMPIDIS, Erlangen (DE); Maximilian Frank GERNER, Erlangen (DE)

(73) Assignee: Valeo eAutomotive Germany GmbH, Erlangen (DE)

(21) Appl. No.: 18/548,420

(22) PCT Filed: Oct. 28, 2021
(86) PCT No.: PCT/EP2021/079917

§ 371 Date: Aug. 30, 2023

(30) Foreign Application Priority Data
Mar. 3, 2021 (DE) 10 2021 202 042.9

(51) Int. Cl. H02M 1/14; B60L 53/22; H02M 7/5387

(52) U.S. Cl. CPC H02M 1/14; B60L 53/22; H02M 7/5387; B60L 2210/40

(57) ABSTRACT

A power converter for an onboard electrical system of a vehicle which can be electrically driven, has a first line for a first potential, a second line for a second potential which differs from the first potential, and a third line for a reference potential which lies between the first potential and the second potential. A filter device has a first capacitor and a second capacitor and is designed to establish a first electrically conductive connection between the first line and the third line via the first capacitor and an electrically conductive connection between the second line and the third line via the second capacitor on the basis of control information and sever the electrically conductive connections along at least one current direction.

The present invention relates to a power converter for an onboard electrical system of an electrically drivable vehicle. In addition, the invention relates to an onboard electrical system for an electrically drivable vehicle.

Electrical components intended for automotive applications must comply with a large number of electromagnetic compatibility specifications. For example, in particular limit values are provided for electromagnetic interference. Particularly in view of the trend towards increasing nominal voltages provided by a traction battery of an onboard electrical system, effective filtering of such interference in a power converter of the vehicle is required. It is generally known to arrange two capacitors between a first line and a second line for different potentials of the power converter and a third line for a reference potential, which filter common-mode interference as so-called Y capacitors.

Such a power converter is known, for example, from DE 10 2017 110 608 A1, which discloses an inverter with two supply lines. The supply lines are connected in a filter circuit for reducing common-mode interference which comprises a filter stage. In the filter stage, each supply line is connected to ground via a Y capacitor.

During operation of the power converter, the capacitors store electrical energy between the first and second lines on the one hand and the third line, which is typically at a common potential of a chassis of the vehicle as reference potential, on the other. In certain operating situations of the vehicle, however, there is a requirement that only a limited amount of energy may be stored in the capacitors, in particular so that this amount of energy cannot flow out as current via the third line in the event of a fault. However, this amount of energy increases quadratically with the voltage across the capacitors, which in turn is proportional to the nominal voltage of the traction battery of the onboard electrical system. Consequently, the capacitance of the capacitors would have to be disproportionately reduced when the nominal voltage is increased in order to comply with predetermined limits on the amount of energy. However, reducing the capacitance reduces the filtering effect. There is thus a conflict of objectives between filter efficiency and the maximum permissible amount of energy stored.

The object of the invention is to describe a possibility for operating an onboard electrical system of an electrically drivable vehicle with a power converter which allows a high filter efficiency even at high nominal voltage of a traction battery.

According to the invention, this object is achieved by a power converter for an onboard electrical system of an electrically drivable vehicle, having a first line for a first potential, a second line for a second potential which differs from the first potential, a third line for a reference potential which lies between the first potential and the second potential, and a filter device, which has a first capacitor and a second capacitor and is designed to establish an electrically conductive connection between the first line and the third line via the first capacitor and to establish an electrically conductive connection between the second line and the third line via the second capacitor in dependence on control information and to disconnect the electrically conductive connections along at least one current direction.

The power converter according to the invention for an onboard electrical system of an electrically drivable vehicle has a first line for a first potential. The power converter further has a second line for a second potential. The second potential differs from the first potential. The power converter further has a third line for a reference potential. The reference potential lies between the first potential and the second potential. The power converter further has a filter device. The filter device has a first capacitor. The filter device further has a second capacitor. The filter device is designed to establish an electrically conductive connection between the first line and the third line via the first capacitor, and to establish an electrically conductive connection between the second line and the third line via the second capacitor in dependence on control information, and to disconnect the electrically conductive connections along at least one current direction.

The filter device of the power converter according to the invention allows the electrically conductive connections across the respective capacitor to be interrupted depending on the control information, which can be obtained from an external control device, for example. Depending on the operating state of the vehicle represented by the control information, the electrically conductive connections can be established to realize a filtering effect of the capacitors or disconnected to avoid an energy flow from the capacitors to the third line. Advantageously, the capacitors can thus be designed in terms of their capacitance for the desired filtering effect to avoid electromagnetic interference without being restricted because of the amount of electrical energy that can be stored in the capacitors with regard to operating situations in which a flow of energy into the third line is to be limited.

The first line and the second line are formed in particular by busbars into which the filter device is connected. The third line preferably comprises one or more electrical conductors which are connected or connectable to a housing of the power converter and/or to a chassis of the vehicle.

For the purposes of the present invention, the term “potential” means an electrostatic potential. The reference potential is in particular a chassis potential of the vehicle. The reference potential may also be understood or referred to as a ground potential or earth potential. Preferably, the first potential is higher than the second potential. It is further preferred if a difference between the first potential and the third potential and between the third potential and the second potential is equal. In other words, the onboard electrical system is symmetrical.

Preferably, the filter device is designed to establish the electrically conductive connections when a first information state of the control information is present, so that the first capacitor and the second capacitor act as filters for common-mode interference on the first and second lines. In particular, the first information state represents normal operation of the power converter. The filtering device may further be designed to disconnect the electrically conductive connections when a second information state of the control information is present, so that an energy flow from the first capacitor and the second capacitor into the third line is avoided. The second information state represents, in particular, an operating state of the onboard electrical system in which the latter is connected to a vehicle-independent electrical network, in particular for charging a traction battery of the onboard electrical system. The first capacitor and the second capacitor can also be understood or referred to as Y-capacitors.

The first capacitor and the second capacitor may be part of a filter stage of the filter device. The filter stage may further comprise a third capacitor connected between the first and second lines. Such a third capacitor may also be understood as an X-capacitor. The filter stage may further comprise a choke formed, for example, by a ferrite core or a nanocrystalline core around the first and second lines.

The filter device may comprise a second filter stage corresponding to and downstream of the first filter stage. The filter device can be designed to establish and disconnect an electrically conductive connection between the first line and the third line via the first capacitor of the second filter stage, and to establish and disconnect an electrically conductive connection between the second line and the third line via the second capacitor of the second filter stage in dependence on the control information. In all other respects, the explanations regarding the first filter stage can be transferred to the second filter stage.

It may further be provided that the filter device is designed to establish the electrically conductive connections in an operating state of the power converter in which a voltage above a predetermined voltage threshold is present between the first line and the second line, and to disconnect the electrically conductive connections when the control information, in particular the second information state, is received. This allows the filtering effect of the filtering device to be realized as soon as the voltage between the first line and the second line exceeds the voltage threshold value. This enables a normally on operation of the filter device. The voltage threshold value may be at most sixty volts, preferably at most forty volts, particularly preferably at most twenty volts.

It is preferably provided that the filter device has at least one switching device which has a first terminal, a second terminal, a control terminal for receiving the control information and a switching unit which has at least one control input and is designed to switch a current flow between the first terminal and the second terminal in dependence on the control information. The switching unit may be designed to conduct and/or block the current flow unidirectionally. Alternatively, the switching unit may be designed to conduct and/or block the current flow bidirectionally.

The switching element may comprise an electromechanical switch, for example a relay or a contactor. Alternatively, the at least one switching element may comprise a semiconductor switch and a diode connected in antiparallel therewith. The or a respective switching element may be an insulated gate bipolar transistor (IGBT) or a field effect transistor, such as an insulated gate field effect transistor (IGFET), in particular a power mosfet, or a junction field effect transistor (JFET). In this case, the antiparallel diode may be formed by a body diode of the field-effect transistor. Alternatively, the or a respective switching element may be a bipolar transistor or a triac, in particular an opto-triac. The switching element may also comprise a reverse-blocking IGBT (RB-IGBT).

The at least one control input of the switching unit may comprise a first control input and a second control input.

In order to realize the bidirectionally conducting and/or blocking switching unit, it can be provided that the switching unit comprises a first switching element and a second switching element, which each have a terminal of a first type, a terminal of a second type, a terminal of a third type and a switching path formed between the terminal of the first type and the terminal of the second type, the conduction state of which can be predetermined in dependence on a voltage present between the terminal of the third type and the terminal of the second type, wherein the terminals of the second type of the first switching element and of the second switching element are connected to one another and the terminals of the third type are controllable in dependence on the control information. The terminal of the first type is in particular a drain terminal or a collector terminal. The terminal of second type is in particular a source terminal or an emitter terminal. The terminal of the third type is in particular a gate terminal or a base terminal. Thus, a switching unit in a common-source circuit or a common-emitter circuit can be formed with two merely unidirectionally blocking switching elements. In this case, the terminals of the third type of the switching elements can receive the same signal representing the control information.

It may further be provided that the terminal of the first type of the first switching element forms the first terminal of the switching device and the terminal of the first type of the second switching element forms the second terminal of the switching device, wherein the first control input is connected to the terminals of the third type of the first switching element and the second switching element and the second control input is connected to the terminals of the second type of the first switching element and the second switching element.

Alternatively, it can be provided that the switching unit comprises a first switching element and a second switching element, which each have a terminal of the first type, a terminal of the second type, a terminal of the third type and a switching path which is formed between the terminal of the first type and the terminal of the second type, the conduction state of which can be predetermined in dependence on a voltage applied between the terminal of the third type and the terminal of the second type, wherein the terminals of the first type of the first switching element and of the second switching element are connected to one another. Thus, the switching unit can be formed as a common-drain circuit or a common-collector circuit.

Alternatively, it can be provided that the switching unit has a bridge rectifier with a switching element connected in parallel. This circuit can also be used to realize a bidirectionally conducting and/or blocking switching unit.

The switching unit may further have a suppressor diode connected to the first terminal and the second terminal of the switching device and/or connected in parallel with the switching elements.

According to a first preferred embodiment, it is provided that the first capacitor is connected between the first line and the first terminal of a first switching device of the at least one switching device, wherein the second terminal of the first switching device is connected to the third line.

It may be provided that the second capacitor is connected between the second line and the second terminal of a second switching device of the at least one switching device, wherein the first terminal of the second switching device is connected to the third line. In this case, both switching devices are connected to the third line. Alternatively, it may be provided that the second capacitor is connected between the third line and the first terminal of a second switching device of the at least one switching device, wherein the second terminal of the second switching device is connected to the second line. In this case, the switching devices are connected in each case to the lower potential between the lines.

In the first preferred embodiment, a dedicated switching device is associated with each of the first capacitor and the second capacitor.

When the electrically conductive connections are established, a common-mode current can flow through the respective capacitor and semiconductor switch or through the antiparallel diode, so that conductivity is provided in both current directions. When using a bidirectionally conducting and/or blocking switching unit, if the electrically conductive connections are disconnected, the capacitors are neither charged nor discharged via the third line, even if a voltage is present between the first line and the second line. If, when using a unidirectionally conducting/and or blocking switching unit, the electrically conductive connections are disconnected, the capacitors will not be charged when a voltage is present between the first line and the second line. If the disconnection occurs whilst a voltage is already present between the first line and the second line, the capacitors can be discharged via a discharge resistor—described in greater detail below—so that the total voltage between the first or second line on the one hand and the third line on the other hand drops in a steady, i.e. discharged, state across the switching device.

Preferably, a maximum permissible blocking voltage of a respective switching unit is at least the nominal voltage of the onboard electrical system or half the voltage to be expected between the first line and the second line. In this way, voltages can also be effectively blocked even in the event of a fault in the case of short circuits between one of the first and second lines and the third line. In order to select the maximum permissible blocking voltage lower than the nominal voltage, additional symmetry ratios of the onboard electrical system can be taken into account when designing the switching unit.

In a preferred development, the switching device can have a normal operating circuit. This has in particular a voltage limiting element, preferably a Zener diode, which is connected between the control input of the switching unit and the second terminal of the switching device. Alternatively or additionally, the normal operating circuit comprises a resistor element connected between the control input of the switching unit and a third terminal of the switching device which is connected to such a pole of the capacitor that is connected neither to the first terminal nor to the second terminal of the switching device. The resistor element preferably has a resistance value of at least one megohm, preferably at least ten megohms. The resistor element may be formed by a plurality of resistor components connected in series. Preferably, each resistor element has a resistance value of at least one megohm.

In particular, the normal operating circuit enables the previously described normal on operation by supplying the control input of the switching unit with a voltage limited by the voltage-limiting element from the first or the second line as soon as the predetermined voltage threshold value is reached.

The switching device may further have an input circuit connected between the control terminal of the switching device and the control input of the switching unit and designed to control the switching unit to interrupt a connection between the first terminal and the second terminal when the control terminal and the second terminal are at the same potential. In this way, for example, the control information for disconnecting the electrically conductive connection via the first capacitor can be represented by a signal related to the reference potential and for disconnecting the electrically conductive connection via the second capacitor can be represented by a signal related to the second potential. This applies in particular if switching elements of the n-channel type are used.

It should also be noted that the switching device does not suffer any damage even in the case of a voltage resistance test, in which a voltage that is considerably higher than the nominal voltage of the onboard electrical system, for example in the amount of two to four kilovolts, is usually present between the first line and the third line and/or between the second line and the third line. The voltage across the switching unit of one of the switching devices can be limited here, in particular via the antiparallel diode, to its forward voltage, which is regularly of the order of 0.7 volts, while the switching unit of the other switching device can be protected via the normal operating circuit or other protective measures.

As an alternative to the first embodiment, it can also be provided in principle that the first capacitor is connected between the third line and the second terminal of a first switching device of the at least one switching device, wherein the first terminal of the first switching device is connected to the first line. The second capacitor may be connected here between the second line and the second terminal of a second switching device of the at least one switching device, wherein the first terminal of the second switching device is connected to the third line. Alternatively, the second capacitor may be connected between the third line and the first terminal of a second switching device of the at least one switching device, wherein the second terminal of the second switching device is connected to the second line.

According to a second preferred embodiment, it may be provided that the first capacitor is connected to the first line and the second capacitor is connected to the second line, the first capacitor, the second capacitor and the first terminal of the switching device are connected to a common circuit node and the second terminal of the switching device is connected to the third line. Consequently, in the second preferred embodiment, a common switching device is provided in a common current path from the first capacitor and from the second capacitor to the third line. This also has the advantage that, with the same potential difference between the first line or the second line on the one hand and the third line on the other hand, no voltage drop occurs across the switching device.

If multiple filter stages are provided, the first capacitor of the second filter stage may be connected to the first line and the second capacitor of the second filter stage may be connected to the second line, wherein the first capacitor and the second capacitor of the second filter stage may be connected to the common circuit node. Thus, multiple parallel filter stages may be connectable to or disconnectable from the third line by a single switching device.

When the electrically conductive connections are established, a common-mode current can flow through the respective capacitor and through the switching unit. When the electrically conductive connections are disconnected, the first and second capacitors are connected in series and the switching unit blocks a current flow into the third line. The first and second capacitors are then connected in series and act as a capacitor connected between the first and second lines, i.e. as an X-capacitor.

Preferably, a maximum permissible blocking voltage of a respective switching unit is at least the nominal voltage of the onboard electrical system or half the voltage expected between the first line and the second line. In this way, voltages can also be effectively blocked even in the event of a fault in the case of short circuits between one of the first and second lines and the third line. In order to select the maximum permissible blocking voltage lower than the nominal voltage, additional symmetry ratios of the onboard electrical system can be taken into account when designing the switching unit.

It should also be noted that the switching device does not suffer any damage even in the case of a voltage resistance test, in which a voltage that is considerably higher than the nominal voltage of the onboard electrical system, for example two to four kilovolts, is usually present between the first line and the third line and/or between the second line and the third line.

In a preferred embodiment, it is provided that the switching device further comprises a normal operating circuit. The normal operating circuit may comprise a voltage-limiting element, in particular a Zener diode, connected between the first control input and the second control input of the switching unit. Alternatively or additionally, the normal operating circuit may comprise a resistor element connected between the first control input of the switching unit and the first or second line. The resistor element preferably has a resistance value of at least one megohm, preferably at least ten megohms. The resistor element may be formed by a plurality of resistor components connected in series. Preferably, each resistor element has a resistance value of at least one megohm.

In particular, the normal operating circuit enables the previously described normal on operation by supplying the control input of the switching unit with a voltage limited by the voltage-limiting element from the first or the second line as soon as the predetermined voltage threshold value is reached between them.

It may be further provided that the switching device further has an input circuit connected between the first control input and the second control input and designed to drive the switching unit to interrupt a connection between the first terminal and the second terminal by electrically connecting the first control input and the second control input to each other.

In a preferred embodiment, a resistor element for balancing may be provided between the first line and the third line and between the second line and the third line, respectively. One of the resistor elements, in particular the resistor element between the first line and the third line, can be formed by the resistor element of the normal operating circuit. In this way, a charge distribution between the first capacitor and the second capacitor can be balanced in a component-saving manner, at least in certain operating states. The respective resistor element preferably has a resistance value of at least one megohm, preferably at least ten megohms. The respective resistor element may be formed by a plurality of resistor components connected in series. Preferably, each resistor element has a resistance value of at least one megohm.

In a preferred embodiment of the power converter according to the invention, it is provided that the filter device further comprises an isolation device which has an input and an output electrically decoupled from the input and is designed to provide at the output the control information of the at least one switching device provided at the input. The input and the output can be capacitively, inductively or optically decoupled, for example by means of an optocoupler.

Alternatively to the previously described input circuits and/or normal operating circuits, it may be provided that the filter device is designed to provide a control voltage dependent on the control information at the at least one control input of the switching unit. The control voltage may be present at the first and second control inputs or related to a potential at the first terminal or at the second terminal of the switching device at the control input. The control voltage may be provided by the isolation device.

In the power converter according to the invention, the filter device may further comprise a monitoring device which is designed to perform a detection to ascertain whether the first capacitor and the second capacitor are connected to the third line and to provide a monitoring signal describing a result of the detection. Here, the isolation device may comprise a further input and a further output electrically decoupled from the further input and designed to provide at the further output the monitoring signal provided at the further input.

The monitoring device may be connected to the first terminal and to the second terminal of the or a respective switching device.

According to a first embodiment of the monitoring device, this has a switching element, for example a bipolar transistor, for a respective switching device, with a terminal of a first type, a terminal of a second type, a terminal of a third type, and a switching path which is formed between the terminal of the first type and the terminal of the second type, the conduction state of which can be predetermined in dependence on a voltage present between the terminal of the third type and the terminal of the second type. The terminal of the third type can be connected to the first terminal of the switching device via a diode. The terminal of the second type is preferably connected to a voltage source. The terminal of the first type is preferably connected to the second terminal of the switching device via a resistor, wherein the monitoring signal can be provided between the terminal of the first type and the resistor. Optionally, it may be provided that the terminal of the third type is connected to the voltage source via a resistor and/or to the second terminal of the switching device via a capacitor.

According to a second embodiment of the monitoring device, this further comprises a controlled current source, wherein the current source is connected on the one hand via a diode to the first terminal of the switching device and via a diode to the second terminal of the switching device and on the other hand to the second control input of the switching unit, wherein the monitoring signal can be provided between the diodes and the current source. Furthermore, a voltage-limiting element, for example a Zener diode, can be connected in parallel with the current source.

The power converter according to the invention may further comprise a DC link capacitor connected between the first line and the second line. The power converter according to the invention may further comprise a converter circuit, in particular an inverter circuit or an active rectifier circuit, connected between the first line and the second line. The filter device may be arranged on the side of the DC link capacitor facing away from the converter circuit.

In this respect, the power converter can be designed as an AC-DC converter, a DC-AC converter or a DC-DC converter.

The object forming the basis of the invention is further achieved by an onboard electrical system for an electrically drivable vehicle, having at least one power converter according to the invention, a traction battery, a charging device for charging the traction battery from a vehicle-independent electrical network, and a control device designed to provide the control information for disconnecting the electrically conductive connections when the charging device charges the traction battery.

The charging device can also be realized by a power converter according to the invention.

The object forming the basis of the invention is further solved by an electric drive for a vehicle, having a power converter according to the invention and an electric machine, in particular a rotating electric machine, which is design to drive the vehicle, wherein the electric machine can be supplied with an AC voltage, in particular a three-phase AC voltage, by the power converter. The electric machine can be a synchronous machine, in particular a permanently excited synchronous machine, or an asynchronous machine.

The object forming the basis of the invention is further solved by a vehicle comprising the drive according to the invention and/or the onboard electrical system according to the invention.

All statements relating to the power converter according to the invention can be transferred similarly to the onboard electrical system according to the invention, such that the above-described advantages can also be achieved with said system.

Further details and advantages of the present invention can be found in the exemplary embodiments described below and by means of the drawings. These are schematic representations and show:

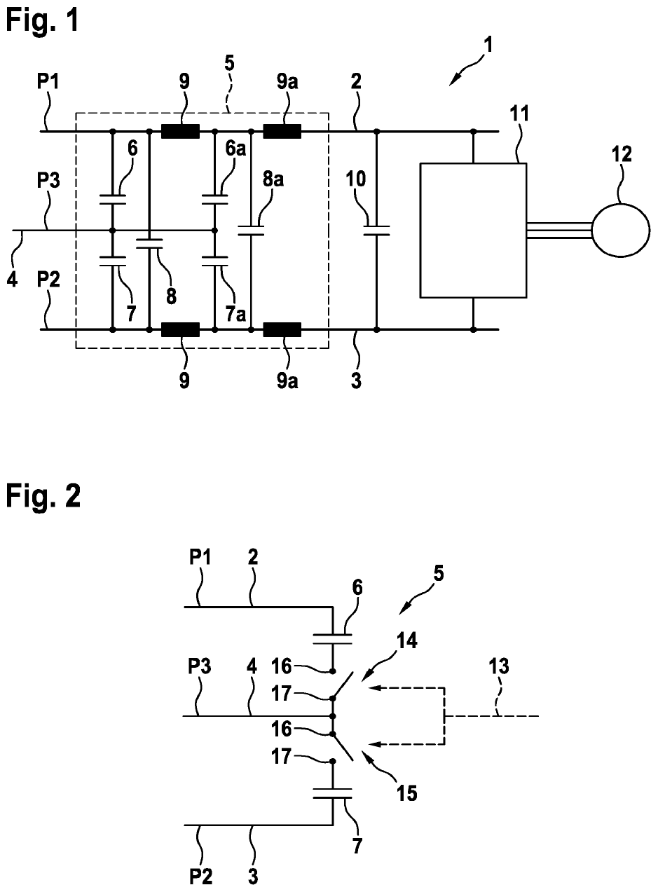

FIG. 1 a block diagram of a first exemplary embodiment of the power converter according to the invention in an operating state in which the electrically conductive connections are established via the capacitors;

FIG. 2 a detail of a schematic circuit diagram of the filter device according to the first exemplary embodiment;

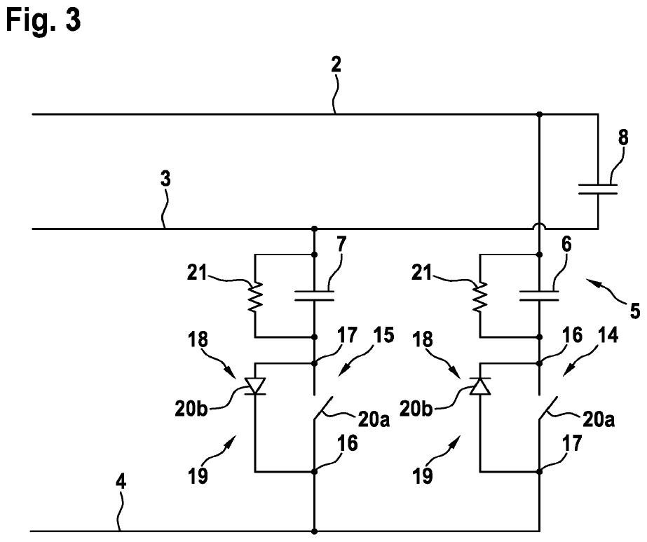

FIG. 3 a detail of a circuit diagram of the filter device according to the first exemplary embodiment;

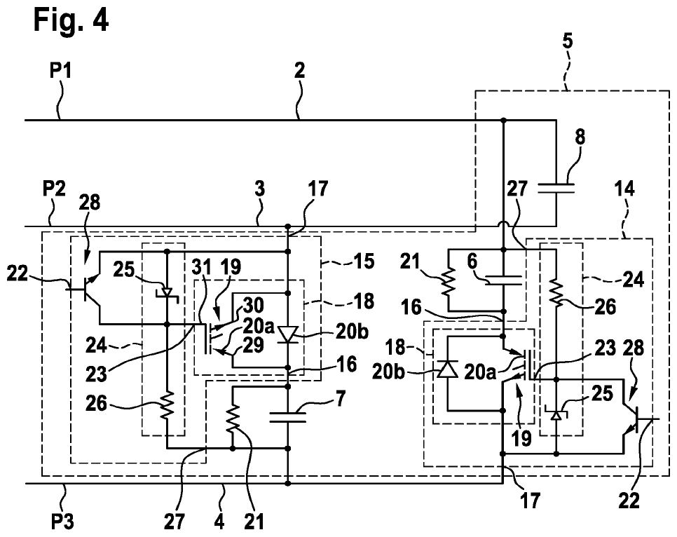

FIG. 4 a detail of a circuit diagram of the filter device according to a second exemplary embodiment of the power converter according to the invention;

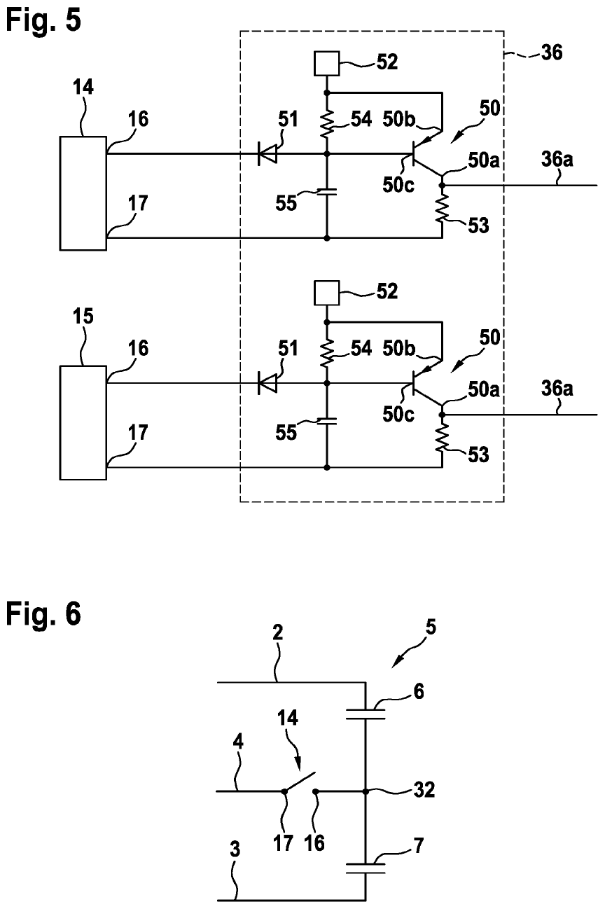

FIG. 5 a circuit diagram of the monitoring device for the second exemplary embodiment;

FIG. 6 a detail of a schematic circuit diagram of the filter device according to a third exemplary embodiment of the power converter according to the invention;

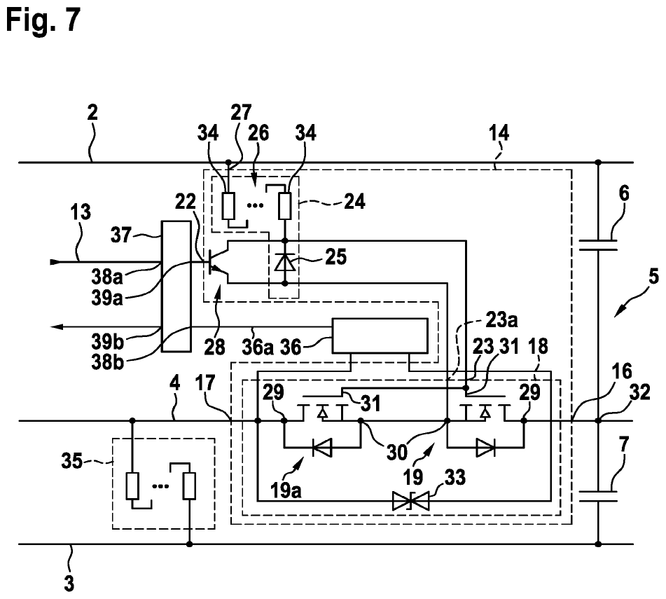

FIG. 7 a detail of a circuit diagram of the filter device according to the third exemplary embodiment;

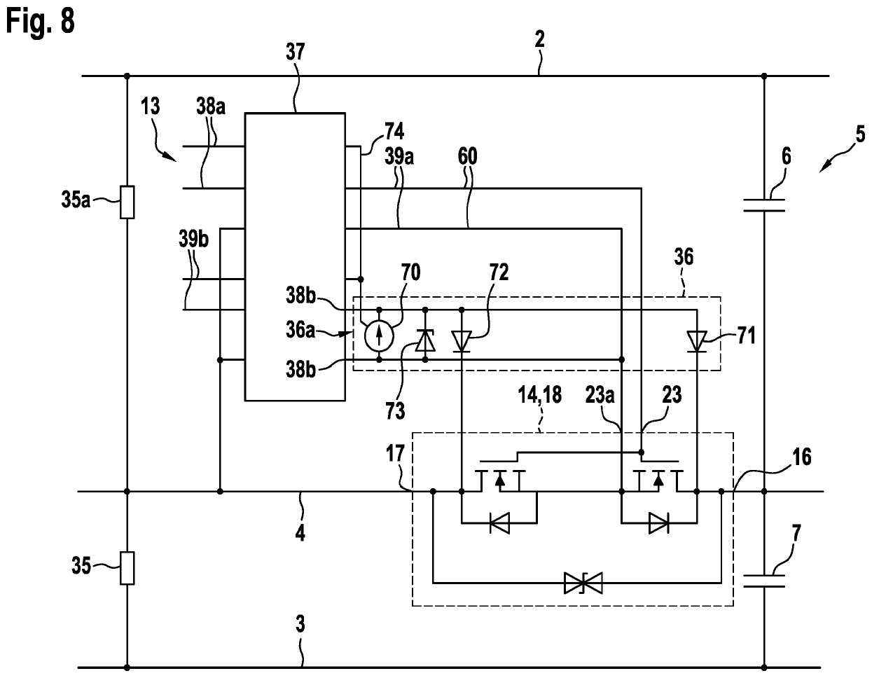

FIG. 8 a detail of a circuit diagram of the filter device according to a fourth exemplary embodiment;

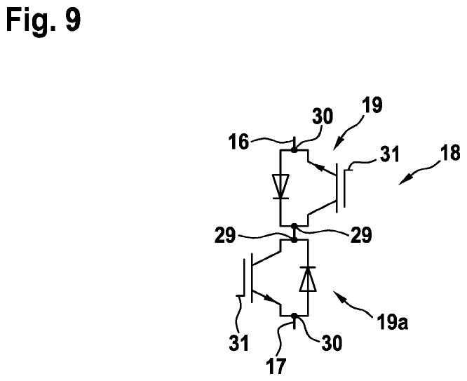

FIGS. 9 to 11 in each case a circuit diagram of a switching unit according to further exemplary embodiments of the power converter according to the invention; and

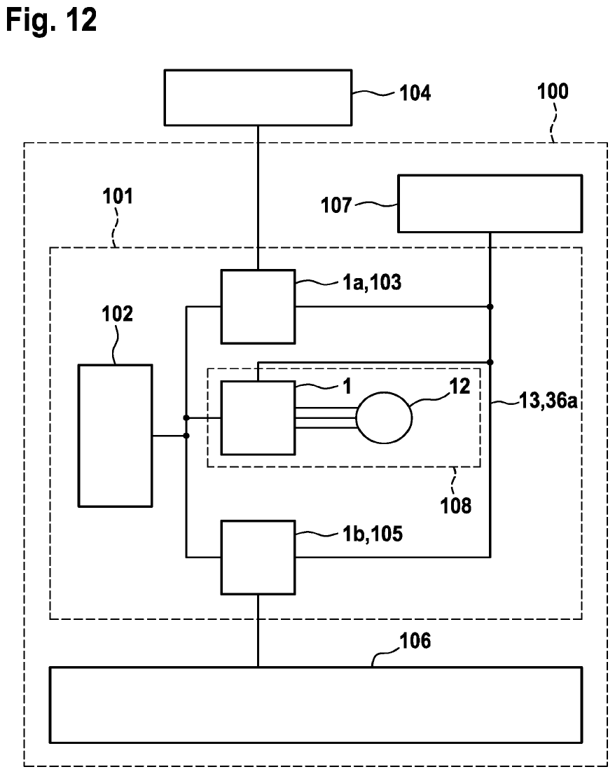

FIG. 12 a basic diagram of a vehicle with an exemplary embodiment of the onboard electrical system according to the invention.

FIG. 1 is a block circuit diagram of a first exemplary embodiment of a power converter 1.

The power converter 1 has a first line 2 for a first potential P1, a second line 3 for a second potential P2 that differs from the first potential P1, and a third line 4 for a reference potential P3 which lies between the first potential P1 and the second potential P2. In the present exemplary embodiment, the second potential P2 is lower than the first potential P1.

The power converter 1 also has a filter device 5. The filter device 5 comprises a first capacitor 6 and a second capacitor 7. FIG. 1 shows here an operating state in which an electrically conductive connection is established between the first line 2 and the third line 4 via the first capacitor 6 and an electrically conductive connection is established between the second line 3 and the third line 4 via the second capacitor 7. The first capacitor 6 and the second capacitor 7 form Y-capacitors here.

As optional components, the filter device 5 further comprises a third capacitor 8, which is connected as a so-called X-capacitor between the first line 2 and the second line 3. Also optionally, the filter device 5 has a choke 9, for example a ferrite core, arranged around the first line 2 and into the second line 3. The capacitors 6, 7, 8 and the choke 9 here form a first filter stage of the filter device 5.

Optionally, a further filter stage can also be provided, which is constructed similarly to the first filter stage and is connected downstream thereof. The second filter stage can have a first capacitor 6a, a second capacitor 7a, a third capacitor 8a and a choke 9a.

Furthermore, the power converter 1 has, by way of example, a DC link capacitor 10 and a converter circuit 11. In the present exemplary embodiment, the converter circuit 11 is an inverter circuit which is designed to convert a DC voltage provided via the first line 2 and the second line 3 into a three-phase AC voltage. The three-phase AC voltage can be used, for example, to supply an electric machine 12 connected to the power converter 1. The filter device 5 is arranged on the side of the DC link capacitor 10 facing away from the converter circuit 11.

FIG. 2 and FIG. 3 are each details of circuit diagrams of the filter device 5 according to the first exemplary embodiment.

The filter device 5 is designed to establish and disconnect the electrically conductive connection between the first line 2 and the third line 4 via the first capacitor 6 and also the electrically conductive connection between the second line 3 and the third line 4 via the second capacitor 7 in dependence on control information 13. For this purpose, the filter device has a first switching device 14 and a second switching device 15. Each switching device 14, 15 has a first terminal 16, a second terminal 17 and a control terminal (not shown) for receiving the control information 13.

The first capacitor 6 is connected between the first line 2 and the first terminal 16 of the first switching device 14. The second terminal 17 of the first switching device 14 is connected to the third line 4. The second capacitor 7 is connected between the second line 3 and the second terminal 17 of the second switching device 15. The first terminal 16 of the second switching device 15 is connected to the third line 4.

FIG. 3 further shows a switching unit 18 of a respective switching device 14, 15. The switching unit 18 has a control input (not shown) and is designed to switch a current flow between the first terminal 16 and the second terminal 17, in particular from the first terminal 16 to the second terminal 17, in dependence on the control information 13. The switching unit 18 has a switching element 19 with a semiconductor switch 20a and with a diode 20b connected antiparallel thereto. For example, the switching element 19 is an insulated gate bipolar transistor (IGBT) and is formed by a separate diode component. Alternatively, the switching element 19 and the diode 20 may be formed by an insulated gate field effect transistor (IGFET), for example a power mosfet, wherein the diode 20b is realized by its body diode. Alternatively, the switching element 19 is formed by an electromechanical switch, for example a relay or a contactor.

FIG. 3 further shows two discharge resistors 21, which are connected in parallel with the first capacitor 6 and the second capacitor 7, respectively. Through the discharge resistors 21, electrical energy stored in the capacitors 6, 7 can be converted into heat when the electrically conductive connections across the capacitors 6, 7 are disconnected by the switching device 14, 15, i.e., when the respective switching element 19 blocks.

The switching devices 14, 15 shown in FIG. 2 and FIG. 3 can be provided in a corresponding manner for the further first and second capacitors 6a, 7a of the second filter stage shown in FIG. 1 and can be controlled by the same control information 13.

FIG. 4 is a detail of a circuit diagram of the filter device 5 according to a second exemplary embodiment of the power converter 1. The statements for the first exemplary embodiment can be transferred to the second exemplary embodiment, unless otherwise described below. Components that are the same or have the same effect are provided with identical reference signs here.

FIG. 4 first shows the control terminals 22 of the first switching device 14 and of the second switching device 15. Also shown are the control inputs 23 of a respective switching unit 18 of the first switching device 14 and the second switching device 15.

In the second exemplary embodiment according to FIG. 4, the first capacitor 6 is connected between the first line 2 and the first terminal 16 of the first switching device 14. The second terminal 17 of the first switching device 14 is connected to the third line 4. The second capacitor 7 is connected between the third line 4 and the first terminal 16 of the second switching device 15. The second terminal 17 of the second switching device 15 is connected to the second line 3.

The switching devices 14, 15 each further include a normal operating circuit 24.

The normal operating circuit 24 comprises a voltage-limiting element 25 connected between the control input 23 of the switching unit 18 and the second terminal 17. The voltage-limiting element is, for example, a Zener diode, the cathode of which is connected to the control input 23 and the anode of which is connected to the second terminal 17.

In addition, the normal operating circuit 24 has a resistor element 26. The resistor element 26 is connected between the control input 23 of the switching unit 18 and a third terminal 27 of the switching device 14, 15. The third terminal 27 is connected to the pole of the capacitor 6, 7 that is connected neither to the first terminal 16 nor to the second terminal 17 of the switching device 14, 15. In the present exemplary embodiment, the third terminal 27 of the first switching device 14 is connected to the first line 2 and the third terminal 27 of the second switching device 15 is connected to the third line 4. By way of example, the resistor element 26 has a resistance value of more than ten megohms and is formed of a plurality of resistor elements, for example thirteen, connected in series, each having a resistance value of one megohm.

In addition, each switching device 14, 15 further comprises an input circuit 28. The input circuit 28 is connected between the control terminal 22 of the switching device 14, 15 and the control input 23 of the switching unit 18 and is designed to control the switching unit 18 to interrupt the electrically conductive connection between the first terminal 16 and the second terminal 17 when the control terminal 22 and the second terminal 17 are at the same potential. In the present exemplary embodiment, the control information 13 (see FIG. 2) can be represented for the first switching device 14 by a signal lying at the reference potential P3 and for the second switching device 15 by a signal lying at the second potential P2. The input circuit here has, by way of example, a switching element in the form of an npn bipolar transistor.

More specifically, the switching element 19 of the switching unit 18 of a respective switching device 14, 15 has a terminal of a first type 29, a terminal of a second type 30, a terminal of a third type 31, and a switching path which is formed between the terminal of the first type 29 and the terminal of the second type 30, the conduction state of which can be predetermined in dependence on a voltage applied between the terminal of the third type 31 and the terminal of the second type 30, wherein, for the sake of clarity, the terminals 29 to 31 are shown only in the case of the second switching device 15. The terminal of the first type 29 is connected to the first terminal 16, the terminal of the second type 30 is connected to the second terminal 17, and the terminal of the third type 31 is connected to the control input 23. In an embodiment of the switching unit 18 with an IGBT, the terminal of first type 29 is a collector terminal, the terminal of the second type 30 is an emitter terminal, and the terminal of the third type 31 is a gate terminal. In an embodiment of the switching unit 18 with an IGFET, the terminal of the first type 29 is a drain terminal, the terminal of the second type 30 is a source terminal, and the terminal of the third type 31 is a gate terminal.

FIG. 5 is a circuit diagram of a monitoring device 36 for the second exemplary embodiment of the power converter 1.

The optional monitoring device 36 is designed to perform a detection to ascertain whether the first capacitor 6 and the second capacitor 7 are connected to the third line 4, and to provide a monitoring signal 36a describing a result of the detection.

The monitoring device 36 has, for each switching device 14, 15, a switching element 50, here in the form of a pnp bipolar transistor, having a terminal of a first type 50a, a terminal of a second type 50b, a terminal of a third type 50c, and a switching path which is formed between the terminal of the first type 50a and the terminal of the second type 50b, the conduction state of which can be predetermined in dependence on a voltage present between the terminal of the third type 50c and the terminal of the second type 50b. The terminal of the third type 50c is connected to the first terminal 16 of the switching device 14, 15 via a diode 51. The terminal of the second type 50b is connected to a voltage source 52. The terminal of the first type 50a is connected to the second terminal 17 of the switching device 14, 15 via a resistor 53, wherein the monitoring signal 36a can be provided between the terminal of the first type 50a and the resistor 53. Optionally, it may be provided that the terminal of the third type 50c is connected to the voltage source 52 via a resistor 54 and/or to the second terminal 17 of the switching device 14, 15 via a capacitor 55. In the present exemplary embodiment, the monitoring signal 36a also describes which capacitor 6, 7 is connected to the third line 4.

FIG. 6 and FIG. 7 show details of a filter device 5 according to a third exemplary embodiment of the power converter 1. Here, FIG. 6 is a schematic sketch and FIG. 7 is a circuit diagram. The statements for the second exemplary embodiment can be transferred to the second exemplary embodiment, unless otherwise described below. Components that are the same or have the same effect are provided with identical reference signs here.

In the third exemplary embodiment, one, in particular exactly one, switching device 14 is provided. The first capacitor 6 is connected to the first line 2. The second capacitor 7 is connected to the second line 3. The first capacitor 6, the second capacitor 7 and the first terminal 16 of the switching device 14 are connected to a common circuit node 32. The second terminal 17 of the switching device 14 is connected to the third line 4.

According to the third exemplary embodiment, the switching unit 18 of the switching device 14 has a first control input 23 and a second control input 23a. The switching unit 18 comprises a first switching element 19 and a second switching element 19a, each having a terminal of the first type 29, a terminal of the second type 30, a terminal of the third type 31, and a switching path formed between the terminal of the first type 29 and the terminal of the second type 30, the conduction state of which can be predetermined in dependence on a voltage present between the terminal of the third type 31 and the terminal of the second type 29. The terminals of the second type 30 of the first switching element 19 and of the second switching element 19a are connected to each other. The terminals of the third type 31 can be controlled in dependence on the control information 13 (see FIG. 1).

The terminal of the first type 29 of the first switching element 19 forms the first terminal 16 of the switching device 14. The terminal of the first type 29 of the second switching element 19a forms the second terminal 17 of the switching device 14.

The first control input 23 is connected to the terminals of the third type 31 of the first switching element 19 and of the second switching element 19a. The second control input 23a is connected to the terminals of the second type 30 of the first switching element 19 and of the second switching element 19a.

In the present exemplary embodiment, the switching elements 19, 19a are each formed by an IGFET, by way of example by a power mosfet with a maximum blocking voltage of 1.2 kilovolts. The switching unit 18 forms a bidirectionally conducting and blocking common-source circuit from the two switching elements 19, 19a. In addition, the switching unit 18 has a suppressor diode 33 connected in parallel with the switching elements 19, 19a to the first terminal 16 and to the second terminal 17 of the switching device 14.

As in the second exemplary embodiment, the normal operating circuit 24 has the voltage-limiting element 25 and the resistor element 26, of which individual resistor elements 34 are shown in FIG. 7. Here, the voltage-limiting element 25 is connected between the first control input 23 and the second control input 23a of the switching unit 18. The cathode of the Zener diode is connected to the first control input 23. The anode of the Zener diode is connected to the second control input 23a. The resistor element 26 is connected between the first control input 23 of the switching unit 18 and the third terminal 27 of the switching device 14. The third terminal 27 is connected to the first line 2.

In the third exemplary embodiment, the control terminal 22 is connected to the control inputs 23, 23a via the input circuit 28. The input circuit 28 is formed by way of example by an npn bipolar transistor.

The resistor element 26, together with a resistor element 35 of the filter device 5, serves to balance the charge distribution between the first capacitor 6 and the second capacitor 7 in certain operating conditions. The resistor element 35 is connected between the second line 3 and the third line 4 and is formed similarly to the resistor element 26 of the normal operating circuit 24.

Optionally, the filter device 5 according to the third exemplary embodiment comprises a monitoring device 36.

Optionally, the filter device 5 has an isolation device 37 which has a first input 38a and an output 39a electrically decoupled from the first input 38a and which is designed to provide at the first output 39a the control information 13 of the switching device 14 which is provided at the first input 38a. In addition, the isolation device 37 may comprise a second input 38b and a second output 39b electrically decoupled therefrom and designed to provide at the second output 39b the monitoring signal 36a provided at the second input 38b. The decoupling between a respective input 38a, 38b and a respective output 39a, 39b is performed here optically by means of optocouplers. According to alternative exemplary embodiments, the decoupling takes place inductively or capacitively.

Provided that the first capacitor 6a and the second capacitor 7a of the second filter stage are provided according to FIG. 1, the capacitors 6a, 7a may be connected to the common circuit node 32 so that the switching device 14 is provided jointly for both filter stages.

FIG. 8 is a detail of a circuit diagram of a filter device 5 according to a fourth exemplary embodiment of the power converter 1, to which the statements for the third exemplary embodiment are transferred, unless otherwise described below. Components that are the same or have the same effect are provided with identical reference signs here.

In the fourth exemplary embodiment, a normal operating circuit and an input circuit are omitted. Here, the isolation device 37 provides a control voltage 60 dependent on the control information to the control inputs 23, 23a of the switching unit 18.

FIG. 8 further shows another possible embodiment of the monitoring device 36. The monitoring device 36 has a current source 70 which is connected, on the one hand, via a diode 71 to the first terminal 16 of the switching device 14 and, on the other hand, via a diode 72 to the second terminal 17 of the switching device 14 and, on the other hand, to the second control input 23a of the switching unit 18, wherein the monitoring signal 36a can be provided between the diodes 71, 72 and the current source 70. A voltage-limiting element 73, here in the form of a Zener diode, is further connected in parallel with the current source 70. The current source 70 of the monitoring device 36 is operable here by an operating voltage 74 provided by the isolation device 37.

FIG. 8 further shows another resistor element 35a, which is connected between the first line 2 and the third line 4 and, together with the resistor element 35, serves to balance the charge distribution between the first capacitor 6 and the second capacitor 7. The resistor elements 35, 35a are identically formed.

FIG. 9 to FIG. 11 are each a circuit diagram of a switching unit 18 according to further exemplary embodiments of the power converter 1 according to the invention, which otherwise correspond to the third or fourth exemplary embodiment. Components that are the same or have the same effect are provided with identical reference signs here.

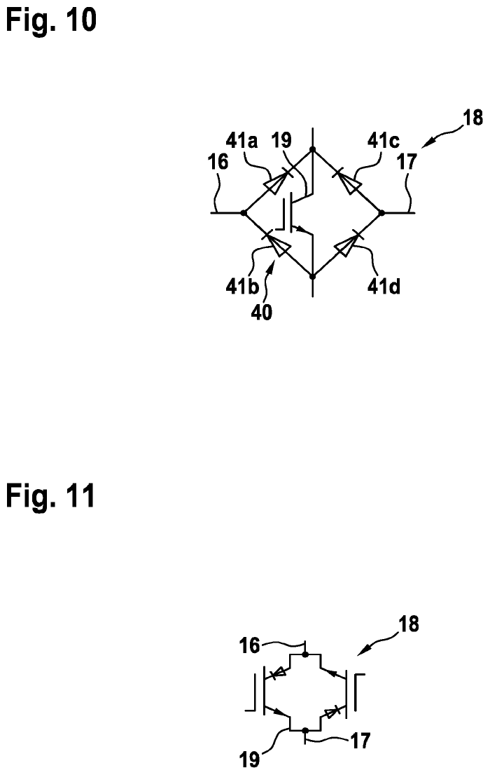

The switching units 18 according to FIG. 9 and FIG. 10 each form a bidirectionally conducting and blocking switching unit on the basis of only unidirectionally conducting and/or blocking switching elements.

In the exemplary embodiment according to FIG. 9, the terminals of the first type 29 of the first switching element 19 and of the second switching element 19a are connected to each other. The terminals of the second type 30 of the switching elements 19, 19a form the terminals 16, 17 of the switching device 14. The switching elements 19, 19a form a common-drain circuit or a common-collector circuit.

In the exemplary embodiment according to FIG. 10, only one switching element 19 is provided, which is connected in parallel to two half-bridges of a bridge rectifier 40 with diodes 41a, 41b, 41c, 41d. The terminals 16, 17 of the switching device 14 are formed by taps between the diodes 41a, 41b or 41c, 41d of a respective half bridge.

In the exemplary embodiment according to FIG. 11, the switching element 19 is formed as a reverse-blocking IGBT (RB-IGBT). The terminals 16, 17 of the switching device 14 are formed by terminals to a switching path of the RB-IGBT.

According to further exemplary embodiments, the isolation device 37 is provided in the power converters 1 according to the first or second exemplary embodiment. According to further exemplary embodiments corresponding to one of the previously described exemplary embodiments, the switching unit 18 is formed by an electromechanical switching element, for example a relay or a contactor.

According to further exemplary embodiments corresponding to the first or second exemplary embodiment, the switching unit 18 of a respective switching device 14, 15 is designed to be bidirectionally conductive and/or blocking and may correspond to the switching unit 18 according to FIG. 7 or FIG. 9 to FIG. 11.

FIG. 12 is a schematic diagram of a vehicle 100 with an exemplary embodiment of an onboard electrical system 101.

The vehicle 100 is an electrically drivable vehicle, such as a battery electric vehicle (BEV) or a hybrid vehicle.

The onboard electrical system 101 has a power converter 1 in accordance with one of the exemplary embodiments described above. In this example, the power converter 1 is designed as a DC-AC converter for the electric machine 12. In addition, the onboard electrical system comprises a traction battery 102, for example with a nominal voltage of at least 400 volts. Also provided is a charging device 103 for charging the traction battery 102 from a vehicle-independent electrical network 104. The charging device 103 may be designed as a DC-DC converter or AC-DC converter between the electrical network 104 and the onboard electrical system 101 and, in accordance with one of the exemplary embodiments described above, as a power converter 1a. Optionally, a DC-DC converter 105 may be provided in the onboard electrical system 101, which is designed to couple the onboard electrical system 101 to a further onboard electrical system 106, for example a low-voltage onboard electrical system with a nominal voltage of 12 or 24 volts, of the vehicle 100. Also, the DC-DC converter 105 power converter 1b may be in the form of a DC-DC converter corresponding to the previously described exemplary embodiments.

The onboard electrical system 101 further comprises a control device 107 designed to provide control information 13 for disconnecting the electrically conductive connections in the filter devices 5 of the power converter 1, and possibly also the power converters 1a, 1b, when the charging device 103 charges the traction battery 102. Optionally, the monitoring signal 36a may be transmitted from the power converter 1 or the power converters 1, 1a, 1b to the control device 107.

The power converter 1 and the electric machine 12 form a drive 108 for the vehicle 100.

1. A power converter for an onboard electrical system of an electrically drivable vehicle, having
a first line for a first potential,
a second line for a second potential which differs from the first potential,
a third line for a reference potential which lies between the first potential and the second potential, and
a filter device which has a first capacitor and a second capacitor and which is designed to establish an electrically conductive connection between the first line and the third line via the first capacitor and an electrically conductive connection between the second line and the third line via the second capacitor on the basis of control information and to disconnect the electrically conductive connections along at least one current direction.

2. The power converter as claimed in claim 1, wherein
the filter device is designed to establish the electrically conductive connections in an operating state of the power converter in which a voltage above a predetermined voltage threshold value is present between the first line and the second line, and to disconnect the electrically conductive connections when the control information is received.

3. The power converter as claimed in claim 1, wherein
the filter device has at least one switching device which has
a first terminal,
a second terminal,
a control terminal for receiving the control information, and
a switching unit which has at least one control input and is designed to switch a current flow between the first terminal and the second terminal in dependence on the control information.

4. The power converter as claimed in claim 3, wherein
the switching unit is designed to conduct and/or to block the current flow bidirectionally.

5. The power converter as claimed in claim 3, wherein
the at least one control input of the switching unit comprises a first control input and a second control input.

6. The power converter as claimed in claim 4, wherein
the switching unit comprises a first switching element and a second switching element, which each have a terminal of a first type, a terminal of a second type, a terminal of a third terminal and a switching path formed between the terminal of the first type and the terminal of the second type, the conduction state of which can be predetermined in dependence on a voltage present between the terminal of the third type and the terminal of the second type, wherein the terminals of the second type of the first switching element and of the second switching element are connected to one another and the terminals of the third type are controllable in dependence on the control information, wherein the terminal of the first type of the first switching element forms the first terminal of the switching device and the terminal of the first type of the second switching element forms the second terminal of the switching device, wherein the first control input is connected to the terminals of the third type of the first switching element and of the second switching element and the second control input is connected to the terminals of the second type of the first switching element and of the second switching element.

7. The power converter as claimed in claim 4, wherein
the switching unit has
a first switching element and a second switching element, which each have a terminal of the first type, a terminal of the second type, a terminal of the third type and a switching path formed between the terminal of the first type and the terminal of the second type, the conduction state of which can be predetermined in dependence on a voltage present between the terminal of the third type and the terminal of the second type, wherein the terminals of the first type of the first switching element and of the second switching element are connected to one another, or
a bridge rectifier with a switching element connected in parallel, or
a reverse-blocking switching element.

8. The power converter as claimed in claim 3, wherein
the first capacitor is connected between the first line and the first terminal of a first switching device of the at least one switching device, wherein the second terminal of the first switching device is connected to the third line, wherein the second capacitor is connected between
the second line and the second terminal of a second switching device of the at least one switching device, wherein the first terminal of the second switching device is connected to the third line, or
the third line and the first terminal of a second switching device of the at least one switching device, wherein the second terminal of the second switching device is connected to the second line.

9. The power converter as claimed in claim 8, wherein
the switching device further comprises a normal operating circuit, which has
a voltage-limiting element connected between the control input of the switching unit and the second terminal of the switching device, and/or
a resistor element connected between the control input of the switching unit and a third terminal of the switching device, which is connected to such a pole of the capacitor that is connected neither to the first terminal nor to the second terminal of the switching device.

10. The power converter as claimed in claim 3, wherein
the first capacitor is connected to the first line and the second capacitor is connected to the second line, the first capacitor, the second capacitor and the first terminal of the switching device are connected to a common circuit node, and the second terminal of the switching device is connected to the third line.

11. The power converter as claimed in 10, wherein
the switching device further has a normal operating circuit, which has
a voltage limiting element connected between the first control input and the second control input of the switching device, and/or
a resistor element connected between the first control input of the switching unit and the first or second line.

12. The power converter as claimed in claim 1, wherein
the filter device further comprises an isolation device which has an input and an output electrically decoupled from the input and designed to provide at the output the control information of the at least one switching device provided at the input.

13. The power converter as claimed in claim 1, wherein
the filter device has a monitoring device which is designed to perform a detection to ascertain whether the first capacitor and the second capacitor are connected to the third line and to provide a monitoring signal describing a result of the detection.

14. The power converter as claimed in claim 1, further comprising
a DC link capacitor, which is connected between the first line and the second line, and a converter circuit, which is connected between the first line and the second line, wherein the filter device is arranged on the side of the DC link capacitor facing away from the converter circuit.

15. An onboard electrical system for an electrically drivable vehicle, having
at least one power converter as claimed in claim 1, a traction battery, a charging device for charging the traction battery from a vehicle-independent electrical network, and a control device designed to provide control information for disconnecting the electrically conductive connections when the charging device is charging the traction battery.

16. The power converter as claimed in claim 2, wherein
the filter device has at least one switching device which has
a first terminal,
a second terminal,
a control terminal for receiving the control information, and
a switching unit which has at least one control input and is designed to switch a current flow between the first terminal and the second terminal in dependence on the control information.

17. The power converter as claimed in claim 4, wherein
the at least one control input of the switching unit comprises a first control input and a second control input.

18. The power converter as claimed in claim 5, wherein
the switching unit comprises a first switching element and a second switching element, which each have a terminal of a first type, a terminal of a second type, a terminal of a third terminal and a switching path formed between the terminal of the first type and the terminal of the second type, the conduction state of which can be predetermined in dependence on a voltage present between the terminal of the third type and the terminal of the second type, wherein the terminals of the second type of the first switching element and of the second switching element are connected to one another and the terminals of the third type are controllable in dependence on the control information, wherein the terminal of the first type of the first switching element forms the first terminal of the switching device and the terminal of the first type of the second switching element forms the second terminal of the switching device, wherein the first control input is connected to the terminals of the third type of the first switching element and of the second switching element and the second control input is connected to the terminals of the second type of the first switching element and of the second switching element.

19. The power converter as claimed in claim 5, wherein
the switching unit has
a first switching element and a second switching element, which each have a terminal of the first type, a terminal of the second type, a terminal of the third type and a switching path formed between the terminal of the first type and the terminal of the second type, the conduction state of which can be predetermined in dependence on a voltage present between the terminal of the third type and the terminal of the second type, wherein the terminals of the first type of the first switching element and of the second switching element are connected to one another, or
a bridge rectifier with a switching element connected in parallel, or
a reverse-blocking switching element.

20. The power converter as claimed in claim 4, wherein
the first capacitor is connected between the first line and the first terminal of a first switching device of the at least one switching device, wherein the second terminal of the first switching device is connected to the third line, wherein the second capacitor is connected between
the second line and the second terminal of a second switching device of the at least one switching device, wherein the first terminal of the second switching device is connected to the third line, or
the third line and the first terminal of a second switching device of the at least one switching device, wherein the second terminal of the second switching device is connected to the second line.
